(19) United States
(12) Patent Application Publication
(10) Pub. No.: US 2010/0200019 A1
(43) Pub. Date: Aug. 12, 2010

(54) METHOD FOR THE INTERNAL CLEANING OF A CLOTHES WASHING MACHINE

(75) Inventor: Ricardo Prioli, Rio Claro (BR)

Correspondence Address: DARBY & DARBY P.C., P.O. BOX 770, Church Street Station, New York, NY, 10008-0770, US

(73) Assignee: WHIRLPOOL S.A., Sao Paulo - SP (BR)

(21) Appl. No.: 12/666,815

(22) PCT Filed: Jun. 30, 2008
(86) PCT No.: PCT/BR2008/000181

§ 371 Date: Dec. 28, 2009

(30) Foreign Application Priority Data
Jun. 29, 2007 (BR) PI0702144-5

(51) Int. Cl. B08B 9/00

(52) U.S. Cl. 134/22.1

(57) ABSTRACT

A clothes washing machine includes a tank (40) with a basket (50) to be selectively rotated by a motor unit (60), a water feed device (80), an outflow electric pump (90) suctioning the bottom of the tank (40) and discharging into a nsing drain pipe (95), and a control unit (30) for the washing operation to be performed by the machine that encompasses a cleaning stage after the end of a clothes washing stage encompassing an additional inflow of water into tank (40), via water feed device (80), and out-flowing this water by outflow eclectic pump (90), with the additional inflow and outflow of water for the cleaning stage being retained during a period sufficient for all the washing liquid trapped in the drain pipe to be pumped out of it (95) at the end of the washing stage.

### FIELD OF THE INVENTION

This invention refers to a method for the automatic performance of an internal cleaning operation of a clothes washing machine of the type consisting of a fixed tank within which a rotating basket mounted, generally perforated, in order to hold the load of clothes to be washed, with the liquids used during the washing and rinsing stages being removed from the inside of the tank by an electric pump whose outflow pipe is connected to a drain pipe in a rising position, with the end of the outflow pipe positioned at a the same height or slightly higher than the maximum water level in the tank of the machine.

### PREVIOUS TECHNIQUE

As mentioned above, automatic clothes washing machines are designed to automatically wash the load of clothes placed in the basket of the machine, through a sequence of stages that encompasses:
introducing the initial pre-determined amount of water into the tank, generally carrying with it an adequate amount of detergent, in order to form a washing liquid;
wash the load of clothes with the washing liquid, agitating the load of clothes in the basket for a certain time, through rotating a stirrer or spindle in the basket of top-loading machines or the controlled rotation of the basket for front-loading machines;
drain out the washing liquid at the end of the washing stage, switching on the outflow electric pump in order to expel the washing liquid through the drain pipe;
rinse the load of clothes through supplying a second amount of water to the tank, usually carrying an adequate amount of fabric softener, in order to fort rinsing water;
drain out the rinsing water at the end of rinsing stage by switching on the outflow electric pump again, in order to expel the rinsing water through drain pipe; and
optionally, spin-dry the load of clothes by rotating basket at high speed, draining away the liquid resulting from the spin-drying stage by switching on the outflow electric pump.

As is known through the previous technique, the supply of water to the machine is handled through a water feed device, normally an electric valve that is usually kept closed, mounted on a feed pipe, to be connected to the pressurized water network and generally fitted with a flow control valve, in order to a rated water inflow range, regardless of any variation in the pressure of the water supply network, within certain limits.

For these known automatic clothes washing machines, once the washing stage is completed, for example by stirring, the outflow electric pump is switched on in order to expel the washing liquid from the tank, through the drainage pipe or hose, with its lower end being connected to the outflow pipe of the outflow electric pump and its upper outlet being positioned higher, generally level with the upper part of the tank of the machine.

Thus, once the washing liquid has drained away and the outflow electric pump has been switched off, the column of washing liquid left in the drain pipe between its superior end and the electric pump runs back in to the tank by gravity, carrying with it the input material (detergent) and the dirt (removed from the clothes) contained in the washing liquid back in to the basket and into the load of clothes in the basket.

During the subsequent rinsing stage, a second amount of clean water flows into the tank in order to dissolve the detergent used during the previous washing stage, generally by stirring. Thus, the less detergent that remains in the load of clothes and in the washing machine, the more it will be diluted by the rinsing water and the greater the efficiency of the rinsing stage. In addition to the issue of the above-mentioned rinsing performance, another problem of the known solutions lies in the fact that the detergent that flows back into the tank and consequently into the basket, carried by the column of washing liquid in the drain pipe (around one liter) blends with the input material (normally a fabric softener) mixed with the rinsing water, impairing the action of the latter and the end characteristics of the washed clothes.

Another negative aspect related to the backflow of the column of washing liquid into the tank is related to fact that the dirt suspended or diluted therein (foam, particulate residues, threads, etc.) returns to the clothes that await rinsing, with adverse effects on the washing standards to be attained.

Yet another negative aspect related to the backflow of the column of washing liquid into the tank is related to fact that the dirt and detergent contained in the washing liquid tend to adhere to the bottom of the tank and the basket progressively, as well as sticking inside the electric pump and the drain pipe, resulting in an increasingly thick encrustation that is hard to remove later.

The previous technique proposes some solutions for the cleaning the inside of the machine by specific cleaning operations that are separate and independent of the washing operation usually performed by the machine.

The international publication WO 04 080 260 A2 described a method for cleaning the tank of a clothes washing machine, consisting of the following stages:
run water into the tank, without loading it with clothes to be washed;
wash out the tank during the first phase, so that the water penetrates the contaminants and removes contaminants that are lightly stuck to the surface of the tank;
leave the contaminants soaking for a while;
wash out the tank during the second phase, in order to bring the wet contaminants up to the surface of the tank; and
drain the water out of the tank.

This prior cleaning method does not take place during the normal washing operation of the machine, as occurs with the method addressed by this invention, instead requiring a specific operation by the machine in order to clean it, with no load of clothes.

A similar situation occurs with the cleaning method described in Document JP 2004 081 651 A2, which describes a cleaning method that is separate and independent of the washing operation that is normally performed by the machine.

These solutions offered by the previous technique do not discuss the issue of the backflow of the washing liquid and the elimination of this inconvenience by the actual operation of the machine, without altering its construction and requiring only a minor alteration to the control unit.

### SUMMARY OF THE INVENTION

Due to the above-mentioned inconveniences related the backflow of the column of washing liquid from the drain pipe into the tank, an objective of this invention is to provide a method for the internal cleaning of a clothes washing machine of the type under consideration here, which prevents the backflow of the above-mentioned column of washing liquid, without requiring any modification to the construction of the components of the washing machine, and can be put into practice through modifying the command instructions produced by a control unit.

The method in question is applied to a clothes washing machine of the type described in the discussion of the previous technique, with a control unit that is operationally connected to the water feed device, the motor unit and the outflow electric pump, switching them on during the washing operation that encompasses the usual stages of supplying of water and washing with five stirring stages, for example, draining the washing liquid, rinsing with a fresh supply of water, draining the rinsing water and optionally spin-drying the load of clothes and draining the resulting liquid, as already defined.

As set forth in the invention, the washing operation also encompasses a cleaning stage, as a continuation of stage draining off the washing liquid, with an additional inflow of water into the tank through switching on the water feed device, and a outflow of this water through switching on the outflow electric pump, with the additional inflow and outflow of water for the cleaning stage being retained during a period sufficient for all the washing liquid trapped in drain pipe at the end of the washing stage to be pumped out.

The method proposed above may be implemented through a simple alteration to the operating instructions sent by the control unit to the water feed device and the electric outflow pump, allowing the column of washing liquid in the drain pipe to be expelled from the machine before starting the rinse cycle.

### BRIEF DESCRIPTION OF THE DRAWINGS

The invention will be described below, referring to the appended drawings that are presented as examples, whereby:

FIG. 1 represents a simplified schematic vertical cross-section of clothes washing machine of the type to the method covered by this invention is applied; and

FIG. 2 represents the sequence of the stages of the method covered by this invention, in a block diagram.

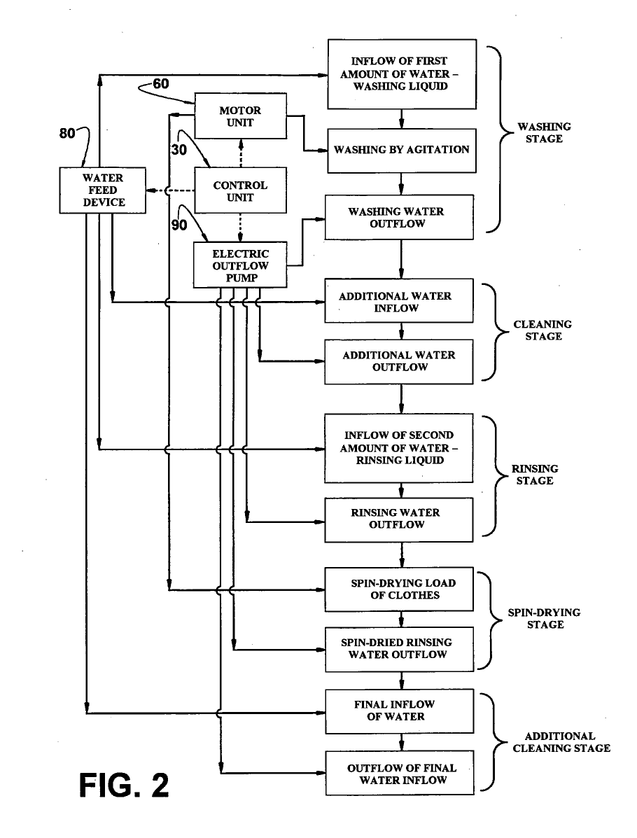

### DETAILED DESCRIPTION OF THE INVENTION

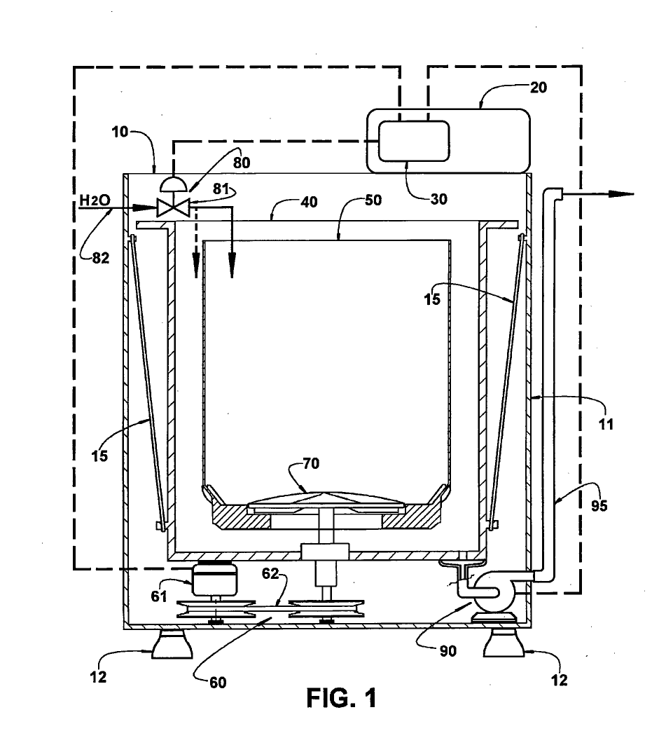

FIG. 1 illustrates a conventional clothes washing machine 10 of the top-loading type, fitted with a casing 11, normally metal. Casing 11 has a supporting foot 12 on each of its corners, to support it on the ground. The machine 10 includes a control panel 20, generally mounted on the casing 11 and fitted with different switches, not described here as they do not form part of this invention and through which the user can select the various functions of the machine.

The machine in question also encompasses a control unit 30, generally fitted inside the control panel 20 and that is schematically illustrated in FIG. 1, with the above-mentioned control unit 30 being built so that it can be properly programmed in order to control the operation of various components and the respective functions of the machine, as will be described in the course of this Report.

A tank 40 is suspended inside the casing 11, sized to receive and hold a load of water to be pumped into the machine during the various operating phases of its operation.

A basket 50 is mounted in the tank 40, generally but not necessarily perforated, which may be rotated by a motor unit 60 around its geometric axis that, on the illustrated configuration of a top-loading machine is placed vertically. The basket 50 spins during a specific spin-drying phase of the machine 10, if any, with the =basket 50 being sized to hold the load of clothes to be washed by the machine 10. It must be understood here that although the a top-loading machine 10 is illustrated with a casing 11, fitted inside with a tank 40, it must be understood that different types of construction may be used for the machine 10, not necessarily top-loading and with the tank not necessarily being defined as a structure suspended inside the casing 11.

In the construction of the machine illustrated as an example, the tank 40 is suspended inside the casing 11 by several suspension rods 15, which are connected underneath to the tank 40, and above to the casing 11, as schematically illustrated in FIG. 1 and as is well-known in the technique Generally, four suspension rods 70 are provided, equally spaced among themselves at around 90° around the tank 40, in the gap between it and the casing 11.

The motor unit 60 is generally assembled on the containment drum 40, consisting of a motor 61 and a switching mechanism 62, of adequate construction, generally of the belt and pulley type, operationally linked to the basket 50 in order to rotate it during the various operating phases of the machine 10. As illustrated in FIG. 1, the motor unit 60 is operationally connected to the control unit 30, which commands it during the different operating stages of the machine 10.

The machine 10 in question also encompasses a water feed device 80 to supply water to the tank 40, with the above-mentioned water feed device 80 generally defined by an electro-valve 81 mounted on a pipe 82 arranged inside the machine 10, for connection to the pressurized water network, not illustrated in the appended drawings as it is not part of this invention and is an assembly array that is well-known in the technique. As may be noted in FIG. 1, the water feed device 80 is operationally connected to the control unit 30, which will command the different stages of the washing operation, as will be discussed below.

The machine 10 to which the method in question is applied, also encompasses an electric outflow pump 90 assembled in the casing 11, so that its suction device is connected to a region at the bottom of the tank 40 in order to suction out all the liquid in the tank 40 when not in operation, with the electric outflow pump 90 being fitted with an outflow pipe connected to a drain pipe 95, generally defined as a hose made from flexible elastomers material that is arranged in an upflow position, with its lower end being connected to the outflow pipe of the outflow electric pump and its upper end being positioned higher, generally level with the upper part of the tank 40 of the machine.

As already mentioned above, the washing operation of a machine, such as that illustrated in FIG. 1 and considered herein, encompasses an indicial stage when, after the load of clothes to be washed has been placed in the basket 50, the first pre-determined quantity of water flows into the tank 40 through switching on the water feed device 80 through an instruction from the control unit 30, in order to form a washing liquid. Preferably, the stage when the first amount of water flows into the tank 40 is conducted in order to carry the load of detergent that forms the washing liquid, through a constructive and functional device that is well-known in the technique. The first pre-determined quantity of water that flows into the tank 40 is defined by the operating design of the machine and guaranteed by different means that are well-known, in order to ensure that the first pre-determined amount of water, the unit 30 instructs the water feed device 80 to halt the above-mentioned inflow.

Having supplied the tank 40 with the first pre-determined amount of water and defined the washing liquid, the motor unit 60 will be instructed by the control unit 30 to start a washing stage with the load of clothes, for example, through agitation in the basket 50 for a certain length of time for the washing cycle, pre-determined by the design of the machine. In some machines, such as the top-loading type illustrated here, the load of clothes is agitated by a stirrer or spindle 70 assembled in the basket 50 whose rotation switched on by the motor unit 60. In other machines, such as front-loading models with a horizontal spindle, the load of clothes may be agitated by the controlled spin of the basket 50 by the motor unit 60 when instructed to operate in this manner by the control unit 30.

Once the washing by stirring stage is completed, the control unit 30 instructs the electric outflow pump 90 to start the washing liquid drainage stage by suctioning the washing liquid away from the region at the bottom of the tank 40 and pumping it out through the drain pipe 95. When there is no more washing liquid left in the tank 40, the electric outflow pump 90. ceases to pump it, allowing a column of washing liquid to remain in the drain pipe 95 that has not yet been pumped out of the machine.

According to the method proposed herein, a cleaning stage is provided that defines a continuation of the washing liquid drainage stage, consisting of an additional inflow of water into the tank 40 through switching on the water feed device 80 by an instruction from the control unit 30, and pumping out this water by switching on the electric outflow pump 90 also by an instruction from the control unit 30. It must be understood here that this additional cleaning stage takes place at the end of the washing liquid drainage stage, with the control unit 30 simply instructing the water feed device 80 to provide an additional inflow of water into the tank 40. While the additional water flow into the tank 40, the electric outflow pump 90 may continue to operate, with the additional inflow and outflow of water for the cleaning stage being retained during a period sufficient to pump out all the washing liquid remaining in the drain pipe 95 at the end of the washing stage.

The introduction of the above-mentioned additional cleaning stage means that, at the end of the washing stage by stirring, for example, the additional quantity of water flows into the tank 40 while the electric outflow pump 90 continues to operate, allowing the clean water flowing into the tank 40 to be pumped out by the electric outflow pump 90, forcing the column of washing liquid trapped in the drain pipe 95 out of the machine and preventing the above-mentioned column of washing liquid containing detergent and impurities from flowing back into the machine at the end of the washing stage, as occurs with the solutions known to date. It must also be understood that the additional cleaning stage may be take place with the basket 50 in a stationary condition or with the basket 50 rotated by the motor unit 60, instructed by the control unit 30, rotating rapidly in order to spin-dry the clothes and remove any washing water that may be left inside it, with this rotation of the basket continuing while the additional supply of clean water flows into the tank 40 and for the period during which the electric outflow pump 90 continue to operate, pumping out the all the washing liquid resulting from spin-drying the load of clothes and also that trapped in the in the drain pipe 95.

At the end of the additional cleaning stage, the control unit 30 halts the inflow of clean water through the water feed device 80 and also halts the operation of the electric outflow pump 90, whereby only an amount of water remains in the drain pipe 95 that is practically free from detergent and dirt in the washing liquid.

Next, the control unit 30 instructs the water feed device 80 to supply a second inflow of water into the tank 40, forming a rinsing water for a subsequent rinsing stage of the load of clothes. The inflow of the second amount of water is halted by switching off the water feed device 80, commanded by an instruction from the control unit 30. At the end of the time set for the rinsing stage, the control unit 30 instructs the electric outflow pump 90 to start-up operations in order to pump out all the rinsing water from the tank 40 through the drain pipe 95. It must also be understood that the inflow of the second amount of water into the tank 40 for the rinsing stage may be take place in order for this second amount of water to carry in the load of fabric softener in order to form the rinsing water, through a constructive and functional device that is well-known in the technique.

The operation of the machine in question may also optionally include a spin-dry stage for the load of clothes, which normally occurs, through switching on the motor unit 60 to spin the basket 50, draining of the rinsing water resulting from this spin-dry stage through switching on the outflow pump 90, instructed by the control unit 30. In the most common cases where a spin-dry stage is provided for the rinsed the load of clothes, the method in question may also encompass an additional cleaning stage as a continuation of the spin-drying stage of the load of clothes already rinsed with fabric softener, through which the control unit 30 instructs the water feed device 80 to provide another supply of water to tank 40, with this water pumped out by an instruction from the electric outflow pump 90 to switch on, with the above-mentioned additional water supply and the concomitant draining stage maintained for a period sufficient for all the rinsing water remaining in the drain pipe 95 at the end of the rinsing stage to be pumped out, preventing the first amount of water used in a subsequent washing operation of the machine being mixed with column of rinsing water trapped in the drain pipe 95 at the end of the previous washing operation. Although the schema presented in FIG. 1 indicates an inflow of water into the basket 50, it must be understood that the inflow of the first and second amounts of water and also the cleaning water may take place inside at least one of the parts defined by the basket 50, the gap between the basket 50 and tank 40 and also the region at the bottom of the basket 50.

Although only one form of materializing the method in question in a clothes washing machine is schematically illustrated here, it must be understood that alterations may be made to form and layout of the various elements involved in the method, without overstepping the inventive concept defined in the Claims that are appended to this Report.

1. Method for the internal cleaning of a clothes washing machine of the type that encompasses: a tank (40) with a basket (50) inside it for holding the load of clothes that is to be selectively rotated by a motor unit (60); a water feed device (80) to supply water to the tank (40); an outflow electric pump (90) with a suction device connected to an area at the bottom of the tank (40) and with an outflow pipe connected to a drain pipe (95) in an upflow position; and a control unit 30) operationally connected to the water feed device (80), the motor unit (60) and the outflow electric pump (90), in order to switch them on and off during the washing operation that encompasses the following stages:
through switching on the water feed device (80), supply a first pre-determined quantity of water to tank (40), in order to form a washing liquid therein;
wash the load of clothes by agitating in the basket (50) through switching on the motor unit (60) for a certain length of washing time;
drain off the washing liquid at the end of the washing stage by switching on the outflow electric pump (90);
rinse the load of clothes through supplying a second amount of water to tank (40) by switching on the water feed device (80), in order to form a rinsing water therein;
drain off the rinsing water at the end of the rinsing stage, through switching on the outflow electric pump (90) and optionally spin-dry the load of clothes, through switching on the motor unit (60) to rotate the basket (50), and draining off the spin-drying liquid by switching on the outflow pump (90), with the method being characterized by the fact that the washing operation additionally encompasses a cleaning stage, as a continuation of washing liquid drainage stage and that it encompasses an additional inflow of water into the tank (40), through the water feed device (80), and the outflow of this water by switching on the outflow electric pump (90), with the additional inflow and outflow of water for the cleaning stage being retained during a period sufficient for all the washing liquid remaining in the drain pipe (95) to be pumped out of it at the end of the washing stage.

2. Method, as set forth in claim 1, characterized by the fact that the stages of draining the washing liquid and cleaning through an additional inflow of water into the tank (40) are conducted with the basket (50) rotating in the spin-drying stage.

3. Method, as set forth in claim 1, characterized by the fact that the stage of supplying the first quantity of water to the tank (40) takes place in order to carry the load of detergent for the formation of the washing liquid.

4. Method, as set forth in claim 1, characterized by the fact that the inflow of the second amount of water into the tank (40) for the rinsing stage takes place in order to carry the load of fabric softener for the formation of the rinsing water.

5. Method, as set forth in claim 4, characterized by the fact that it also encompasses, as a continuation of the stage that spin-dries the load of clothes already rinsed with a fabric softener, an additional cleaning stage during which an additional supply of water flows into the tank (40), with this water then being pumped out, with an additional inflow and outflow of water being retained for a period sufficient to pump out all the rinsing water trapped in the drain pipe (95) at the final of the rinsing stage.

6. Method, as set forth in claim 5, characterized by the fact that the supply of the first and second amount of water and also the cleaning waters for the inside of at least once of the parts defined by the basket (50), the gap between the basket (50) and tank (40) and the region at the bottom of the basket (50).
